(19) United States
(12) Patent Application Publication
(10) Pub. No.: US 2023/0303001 A1
(43) Pub. Date: Sep. 28, 2023

(54) Rear-View Camera Assembly

(71) Applicant: Motherson Innovations Company Limited, London (GB)

(72) Inventors: Alan FRALEY, Marysville, MI (US); Andrea CLIFTON, Marysville, MI (US)

(21) Appl. No.: 18/178,872

(22) Filed: Mar. 6, 2023

(30) Foreign Application Priority Data
Mar. 24, 2022 (DE) 10 2022 107 023.9

(51) Int. Cl. B60R 1/26; B60R 1/12; H04N 23/90

(52) U.S. Cl. CPC B60R 1/26; B60R 1/12; H04N 23/90; B60R 2300/105; B60R 2300/20; B60R 2001/1223

(57) ABSTRACT

Embodiments of the present disclosure relate to a rear-view assembly comprising a housing, a frame, wherein the frame is secured to a vehicle and the housing is secured to the frame, and at least one camera, having at least one lens is secured to the frame to improve image stability. The rear-view assembly may also include a bezel and a reflective element. The bezel has a bezel aperture which allows the at least one lens to view a rearward direction with respect to the vehicle.

### CROSS-REFERENCE TO RELATED APPLICATION

This application claims priority to German Patent Application No. DE 10 2022 107 023,9, filed on Mar. 24, 2022, which is incorporated by reference herein in its entirety.

### FIELD

The present disclosure relates to a rear-view camera assembly adapted for use with external rear vision mirrors of motor vehicles. More particularly, the present disclosure relates to a viewing and detection system of external rear vision mirrors and/or cameras for motor vehicles in form of a rear-view assembly for a vehicle.

### BACKGROUND

Generally, motor vehicles have a pair of external rear vision mirrors placed at either side of the vehicle such that to obtain a clear sight of the rear end of the vehicle. The mirrors are typically an assembly of combination of mechanical or electro-mechanical components. Typically, the assembly is inclusive of a mirror head that is designed to rotate, in either forward or rearward directions, about a substantially vertical pivot axis. The mirror head is the component which is adjusted with respect to the driving position such that a rear-view of the vehicle is obtained.

There are numerous external rear view mirror assemblies equipped with various manual or motorized or electronic aligning mechanisms that allow the operator or driver to change the angel of the mirror such that to obtain a desired field of view.

Further, in view of several homologation requirements, there exist need to incorporate multiple mirror heads with various class of mirrors having different field of views. In an example scenario, there may be homologation requirements wherein two field of views may be required including a class 2 field of view and a class 4 field of view.

Further, it is observed in various developments that mirrors have been replaced by or incorporated with cameras mounted in the mirror housing to capture a specific field of view and the same is displayed to the driver of the vehicle in a display unit mounted within the cabin of the vehicle. In one example, the camera may be a part of an obstacle detection system, a collision-avoidance system and/or an assisted driving system such as an autopilot feature.

Furthermore, mirrors have been incorporated with cameras to identify the field of view behind and beside the car to alert the driver of other vehicles on the road and potential hazards. The plurality of images or video stream captured by camera devices are transferred to an electronic control unit (ECU). One problem encountered with this type of camera is image stability. As the car travels and experiences vibrations, both from the surface of the road as well as wind, the camera can produce an image with diminished clarity. Additionally, the weight of the camera itself needs to be properly supported to increase stability and improve image quality.

In view of the aforementioned drawbacks and other inherent in the existing state of the art, there is a desire to have a rear-view assembly that can support the weight of the camera as well as improve camera image quality by minimizing vibrations and increasing stability.

### SUMMARY

Thus, it an the object of the present disclosure to provide a rear-view assembly for a vehicle overcoming the drawbacks of the prior art.

This object may be achieved by the features of claim 1. Embodiments of the rear-view assembly of the present disclosure are described in claims 2 to 10.

Various embodiments of the disclosure describe a rear-view assembly for a vehicle comprising: a frame secured to the vehicle and a housing secured to the frame, with at least one camera secured to the frame, wherein the at least one camera comprises at least one lens and wherein the lens is pointing in a rearwardly facing direction. Further, the rearview assembly comprises a bezel secured to the frame wherein the bezel comprises an aperture configured for the lens to view the rearwardly facing direction.

In one example, the frame comprises at least one cavity to house at least one camera.

In one example, a first camera comprises a first lens and a second camera comprises a second lens, both the first and second cameras are secured to the frame.

In one example, the frame comprises a first cavity and a second cavity and the first cavity houses the first camera, and the second cavity houses the second camera.

In one example, the first lens is pointing in the rearwardly facing direction, and the second lens is pointing in an outwardly facing direction.

In one example, the housing comprises a housing aperture configured for the second lens of the second camera to view the outwardly facing direction.

In one example, the at least one camera is secured in the at least one cavity of the frame with a cap having a void configured for the at least one lens to view the rearward direction.

In one example, the at least one camera is secured in the at least one cavity of the frame via a fastener. The fastener may be a screw and/or a snap-fit connection.

In one example, the frame further comprises an actuator, wherein a reflective element is secured to the actuator.

In one example, the rear-view assembly the bezel is housed in the housing and the bezel has a bezel aperture and is configured for the at least one camera to be positioned to view the rearward direction.

Further, a method to operate the rear-view assembly described in any of the examples above comprising at least one camera, is provided in line with claims 11 and 12. The method comprises the following steps: recording a field of view in a rearwardly facing direction by the at least one camera, providing at least part of the recorded field of view in the rearwardly facing direction to an electronic control unit (ECU), the ECU providing at least a part of the recorded field of view in the rearwardly facing direction to a driver of the vehicle. The recorded field of view may also be transmitted to the ECU and used in a part of an obstacle detection and/or a collision-avoidance system that may alert the driver of potential danger or hazards. The method may further provide the steps of the first camera recording the field of view in the rearwardly facing direction to the ECU, the second camera providing a field of view in the outwardly facing direction to the ECU, the ECU providing at least a part of the recorded field of view in the rearwardly facing direction and the outwardly facing direction to the driver of the vehicle.

Still further, a vehicle is provided in line with claim 13, with the vehicle comprising at least one rear-view assembly as described in any of the preceding examples and a field of view as a prominent part of the vehicle to provide a driver with at least a part of the field of view in the rearwardly and outwardly facing direction.

### BRIEF DESCRIPTION OF THE DRAWINGS

The disclosure itself, together with further features and attended advantages, will become apparent from consideration of the following detailed description, taken in conjunction with the accompanying drawings. One or more embodiments of the present disclosure is now described, by way of example only wherein like reference numerals represent like elements and in which:

FIG. 1 shows a rear perspective view of the rear-view assembly of an embodiment of the present disclosure.

FIG. 2 shows a side perspective view of the rear-view assembly of FIG. 1.

FIG. 3 shows a rear perspective view of the rear-view assembly of FIG. 1, with the reflective element and the bezel removed.

FIG. 4 shows a perspective rear view of the frame of the rear-view assembly of FIG. 1.

FIG. 5 shows a perspective side view of the frame of the rear-view assembly of FIG. 1.

FIG. 6 shows a perspective rear view of the bezel of the rear-view assembly of FIG. 1.

FIG. 7 shows an exploded view of the rear-view assembly of FIG. 1.

FIGS. 8a and 8b show block diagrams of the rear-view assembly according to embodiments of the present disclosure.

### DETAILED DESCRIPTION

The term “comprises”, “comprising”, “including”, “having”, “consist of” or any other variations indicate non-exclusive inclusion in order to cover a setup, structure or method that comprises a list of components or steps does not include only those components or steps but may include other components or steps not expressly listed or inherent to such setup or structure or method. Meaning thereby, one or more elements in an apparatus proceeded by “comprises . . . a” does not, without more constraints, preclude the existence of other elements or additional elements in the assembly or apparatus.

For increasing the intelligibility of this assembly, references are made to the embodiment illustrated in the accompanying Figures and description herein below, further, in the following Figures, the same reference numerals are used to identify the same components in alternative views.

This disclosure encompasses a rear-view assembly 100 for a vehicle (not shown) according to an embodiments, with the rear-view assembly 100 comprising a frame 104 secured to the vehicle and a housing 102 secured to the frame 104. The rear-view assembly 100 further comprising at least one camera 106 secured to the frame 104 and wherein the at least one camera 106 comprises at least one lens 108 and wherein the lens 108 is pointing in a rearwardly facing direction with respect to the vehicle. The rear-view assembly 100 further comprises a bezel 110 secured to the frame 104 wherein the bezel 110 comprises a bezel aperture 112 configured for the at least one camera 106 lens 108 to view the rearwardly facing direction with respect to the vehicle.

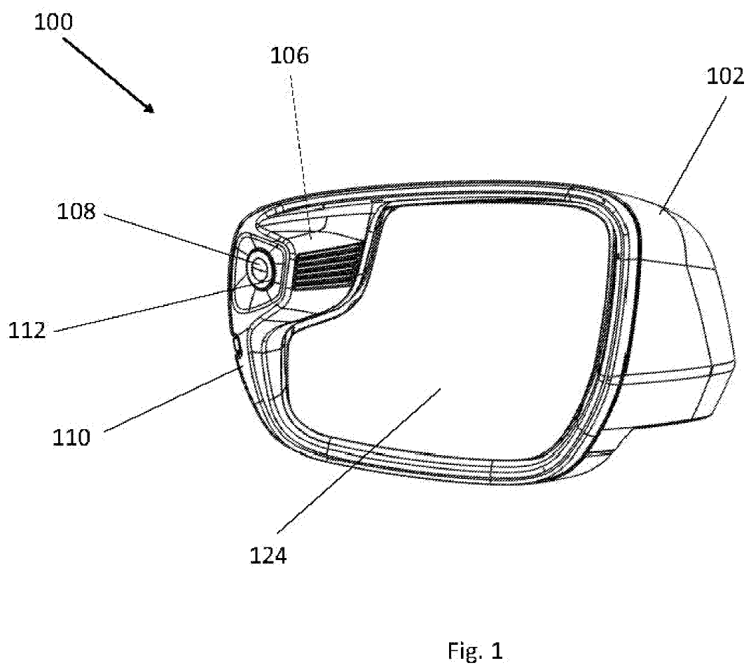

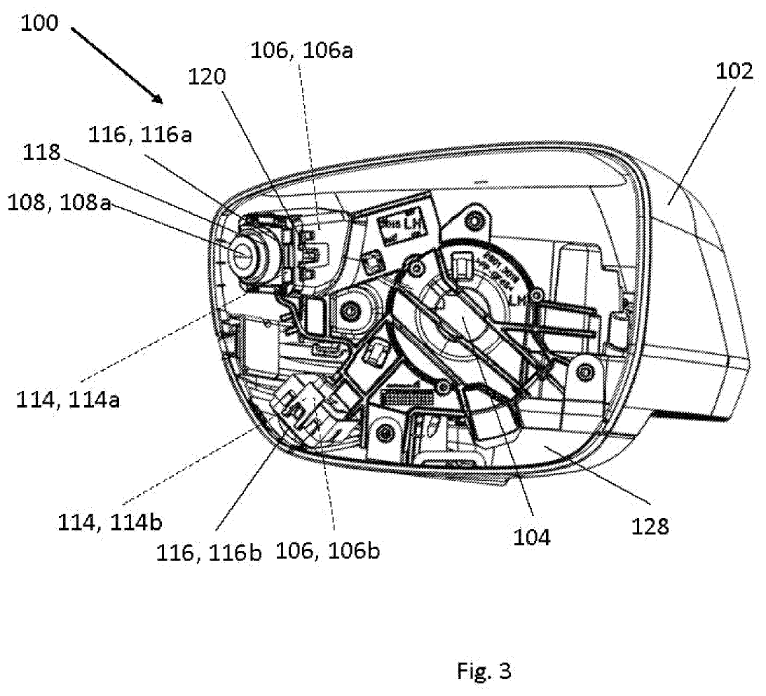

FIG. 1 shows a perspective view from the rear with respect to the vehicle (not shown) of the rear-view assembly 100. The housing 102 may be an outer cover to enclose, protect, and improve aesthetics for the rear-view assembly 100. The housing 102 may enclose the frame 104 and the camera 106. The bezel 110 may be configured to secure to a rear housing opening 128 (shown in FIG. 3). The bezel 110 may also have a bezel aperture 112 that allows for the lens 108 of the camera 106 to view a field of view in the rearwardly facing direction with respect to the vehicle.

FIG. 1 also shows a reflective element 124 which may be utilized to see the field of view behind and to the side of the vehicle. In some examples, the reflective element 124 may be of any suitable type, such as flat, concave, convex, or a combination thereof. In some examples, the reflective element 124 includes a primary reflective element and a secondary reflective element (not shown). In some examples, the secondary reflective element may be a convex mirror. The secondary reflective element may act as a blind spot mirror and may allow the mirror to reflect objects from a wider range of angles than is possible with the primary reflective element. However, the secondary reflective element is optional, and in some examples, only the primary reflective element may be provided.

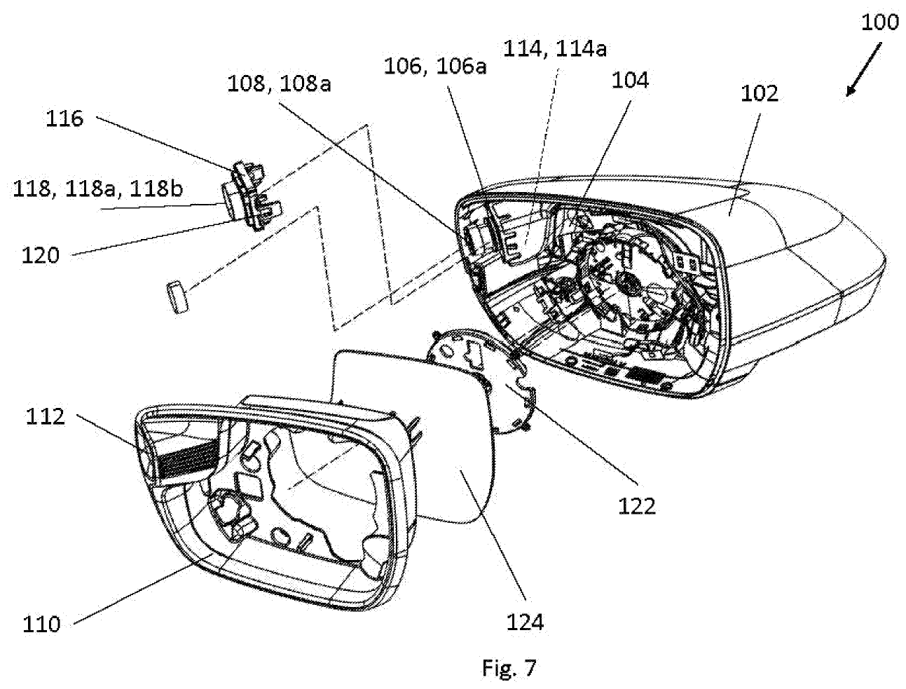

In some examples, the reflective element 124 is pivotally mounted on the frame 104 such that an orientation of the reflective element 124 may be adjusted with respect to the housing 102. In some examples, the frame 104 may include any suitable actuator 122 (shown in FIG. 7) arranged to change the orientation of the reflective element 124 when desired.

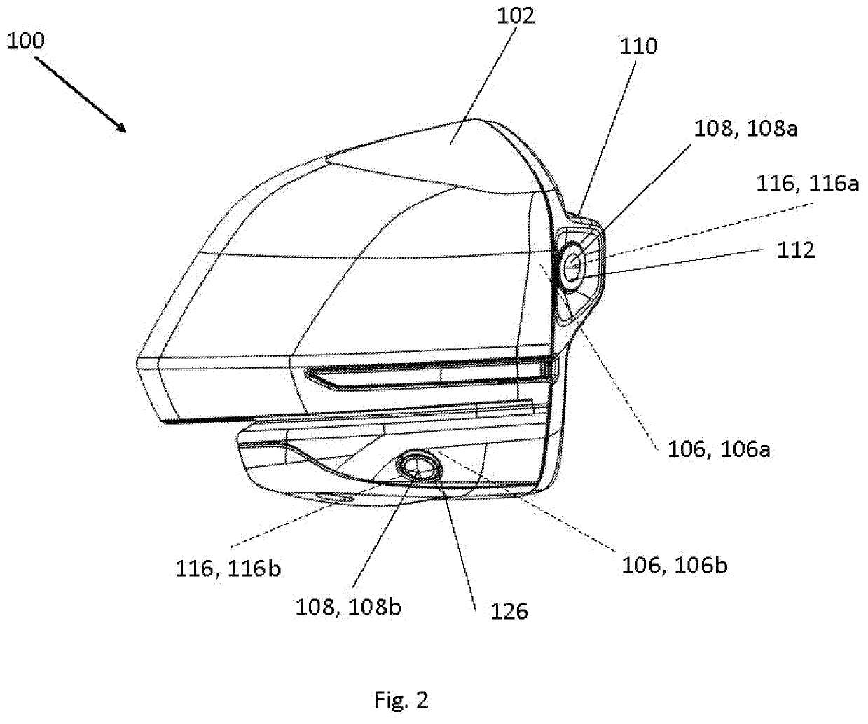

FIG. 2 shows a side perspective view of the rear-view assembly 100, with respect to the driver's side of the vehicle. As previously shown in in FIG. 1, the rear-view assembly comprises the housing 102 and the bezel 110 secured to the housing 102. FIG. 2 also shows a first camera 106a and a second camera 106b. Both the first camera 106a may have a first lens 108a, and the second camera 106b may have a second lens 108b. The bezel 110 may have a bezel aperture 112 to allow the first lens 108a of the first camera 106a to view the surroundings of the vehicle in the rearward direction. The rear-view assembly may also have the second camera 106b with the second lens 108b. The housing 102 may have a housing aperture 126 configured to allow the second lens 108b of the second camera 106b to view the surroundings of the vehicle in an outward direction, with respect to the vehicle.

FIG. 3 shows a rear perspective view of the rear-view assembly 100 with the reflective element 124 and the bezel 110 removed. FIG. 3 shows the inside of the housing 102, which comprises the frame 104, at least one camera 106 having at least one lens 108. In some examples, the rear-view assembly 100 may comprise having two or more cameras 106. In this example the rear-view assembly 100 has two cameras 106, the first camera 106a and the second camera 106b. The first camera 106a may have the first lens 108a and the second camera 106b may have the second lens 108b.

As shown in FIG. 3, the camera 106 is housed in a cavity 114. The cavity 114 may be a pocket or a chamber that may generally be shaped as a cuboid, orthotope, hyperrectangle, or a box. Although other cavity 114 shapes are contemplated, such as a sphere, a cylinder, a cone, or a prism. Any shape could be the cavity 114 so long as it houses at least one camera 106. As shown in FIGS. 3-5, when the cavity may be an orthotope, the cavity 114 may be a closed shape on five of the six sides. The sixth side being open may allow a camera to be inserted and housed within the cavity 114. The sixth side being open may reduce manufacturing and assembly costs.

The cavity 114 of the frame 104 is configured to house a camera 106. The camera 106 may be secured within the cavity 114 by a cap 116. The cap 116 may close the open end of the cavity 114. The cap 116 comprises a void 118 to allow the lens 108 of the camera 106 to view the rearwardly or outwardly facing direction with respect to the vehicle.

FIG. 3 shows an example wherein the frame 104 comprises the first camera 106a, the second camera 106b, wherein each camera may have the respective lens 108a, 108b. The frame 104 may comprise a first cavity 114a and a second cavity 114b. The first cavity 114a may be configured to house the first camera 106a and the second cavity 114b may be configured to house the second camera 106b. In the example shown in FIG. 3, the first camera 106a is secured in the first cavity 114a of the frame 104 by a first cap 116a. Additionally, the second camera 106b is secured in the second cavity 114b of the frame 104 by a second cap 116b. The first lens 108a of the first camera 106a may be oriented in such a way to view the rearward direction with respect to the vehicle. Furthermore, the second lens 108b of the second camera 106b may be oriented in such a way to view the outward facing direction with respect to the vehicle. In another example, the second lens 108b of the second camera 106b may be oriented in such a way to view the downward facing direction with respect to the housing 102. In yet another example, the second lens 108b of the second camera 106b may be oriented in such a way to view the downward facing direction with respect to the housing 102 and the outward facing direction with respect to the vehicle. In some examples, the bezel 110 and the housing 102 may have a plurality of cameras with a plurality of corresponding apertures to allow the cameras to face in the forward direction, the rearward direction, the outward direction, the downward direction, and combinations thereof.

In one example, the first camera 106a is housed in the first cavity 114a and may be secured in place by the first cap 116a. The first cap 116a may have a first void 118a to allow the first lens 108a of the first camera 106a to view the rearward direction with respect to the vehicle. Furthermore, the second camera 106b is housed in the second cavity 114b and may be secured in place by the second cap 116b. The second cap 116bmay have a second void 118b to allow the second lens 108b of the second camera 106b to view the outward direction with respect to the vehicle and/or to view the downward direction with respect to the housing 102.

The cap 116 is secured to the cavity 114 of the frame 104 with a fastener 120. The fastener 120 may be any type that is known in the art. For example, the cap 116 could have a snap-fit connector that interlocks with the cavity 114, as shown in FIG. 3. Alternatively, the cap 116 may utilize a screw as the fastener 120 to secure the camera 106 in the cavity 114.

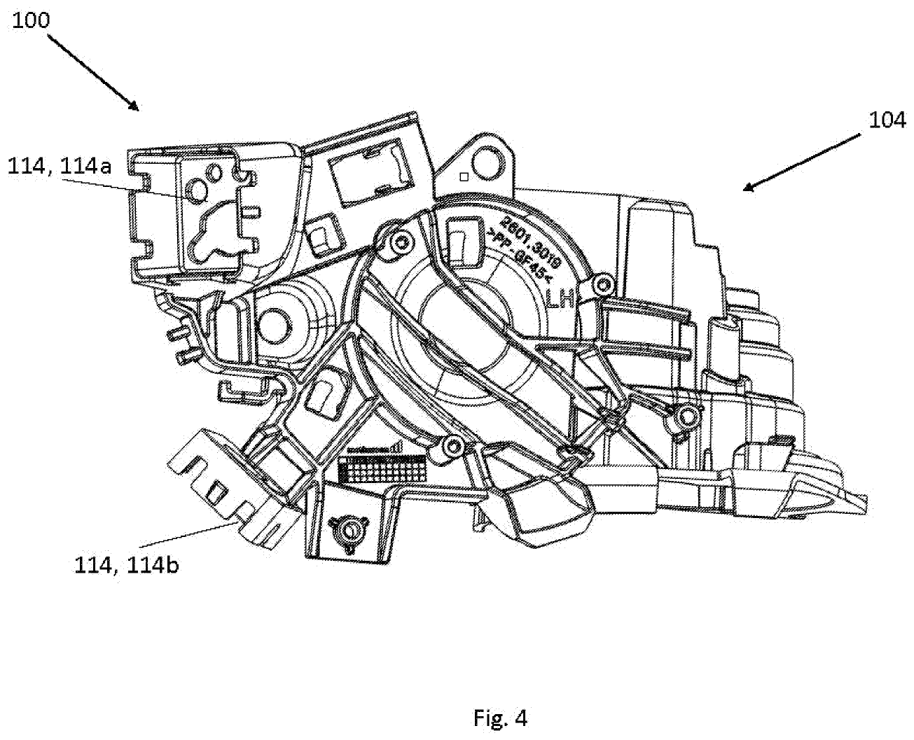

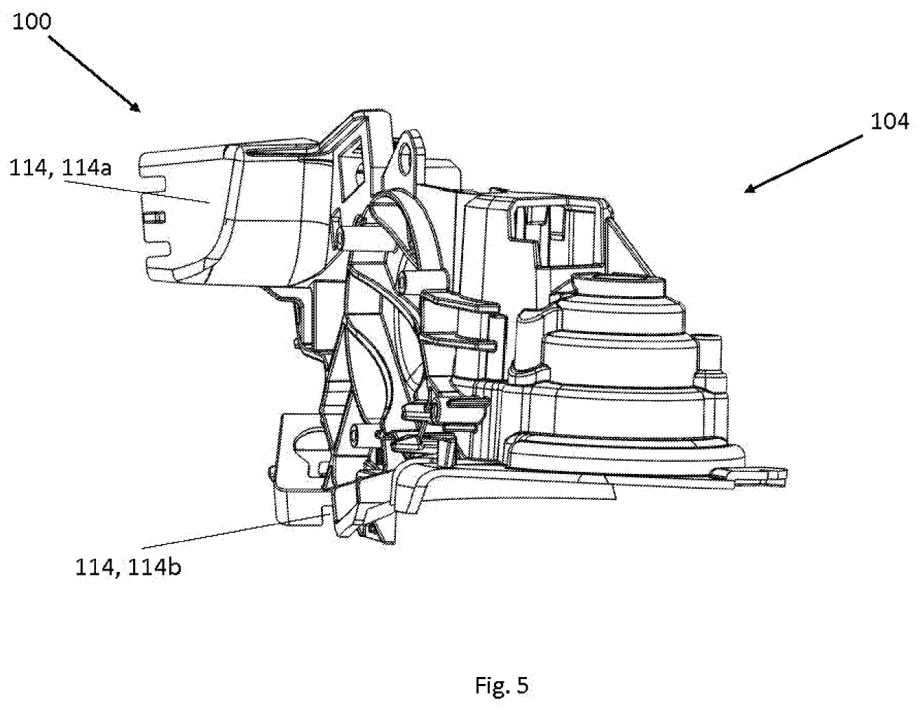

FIGS. 4 and 5 show perspective views of the frame 104 of the rear-view assembly 100. The first and second cavities 114a, 114b are integrated into the frame 104. Said another way, the first cavity 114a and the second cavity 114b are a part of the frame 104. The cavities 114a, 114b are formed of the same material of the frame 104. The frame 104 may be made from any material known to those in the art. Particularly, the frame 104 and the cavities 114a, 114b, that are part of the frame 104, may be formed of a glass-filled polymer. For example, glass-filled polypropylene.

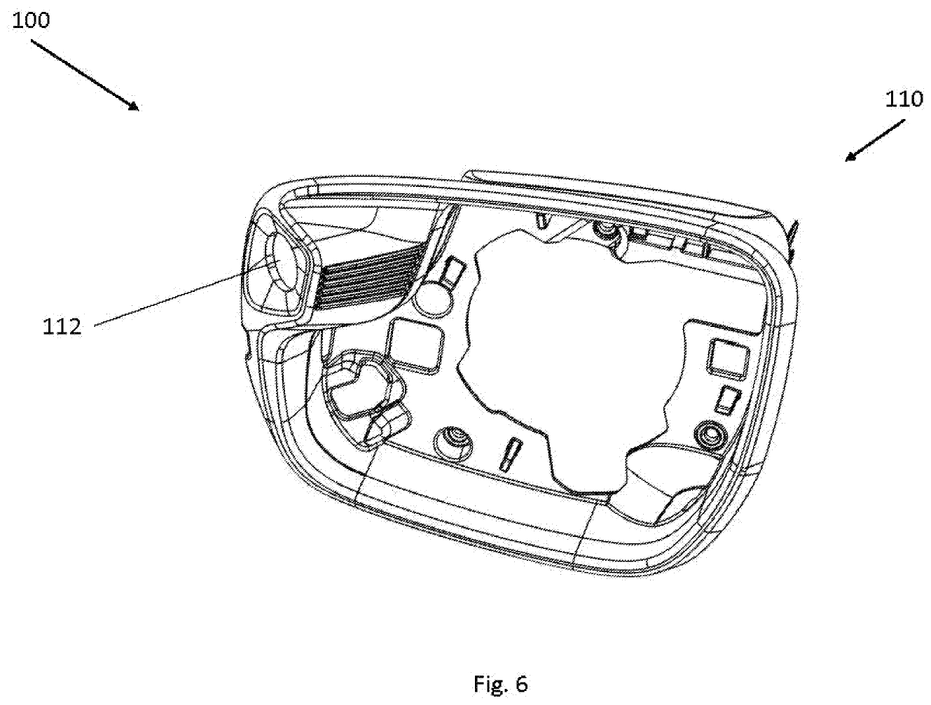

FIG. 6 shows the bezel 110 of the rear-view assembly 100. The bezel 110 has the bezel aperture 112. In the example show in FIG. 6 the bezel aperture 112 is configured to allow the lens 108 of the camera 106 to view the rearward facing direction with respect to the vehicle.

In some examples, the rear-view assembly 100 may also be provided with additional functionality, such as an automatic dimming reflective element, a reflective element defogging/defrosting/de-icing element, a camera 106 lens 108 defogging/defrosting/de-icing element and/or coating, turn indicators, area lights, powered extension, power folding, spotlights, and/or the like.

It should be understood that the camera 106 may be of any type of a digital or analog camera including, but not limited to, a CMOS (Complementary Metal Oxide Semiconductor) image sensor, a CCD camera (charge couple device imaging means), a night vision camera (e.g., an infrared camera), or the like for imaging a still image or a motion picture image. In some examples, the camera 106 may be a part of a night vision system that provides the driver with enhanced viewing of the surrounding environment through a wider field of vision as well as improved visibility when it is dark. In some examples, the camera 106 may be a part of an obstacle detection and/or a collision-avoidance system.

FIG. 7 shows an exploded view of the rear-view assembly 100. The housing 102 may be secured to the frame 104. The frame 104 has at least one cavity 114 and the cavity 114 in combination with the cap 116 are configured to secure at least one camera 106 to the frame 104. The cap 116 may have the fastener 120, the fastener may be a snap-fit connection, and/or a screw configured to secure the cap 116 to the frame 104. The cap 116 may have the void 118 to allow the lens 108 of the camera 106 to view the rearwardly facing direction with respect to the vehicle. The actuator 122 may be coupled to the frame 104 and the reflective element 124 is fixedly secured to the actuator 122 enabling a user or driver to adjust the angle of the reflective element to a suitable field of view. The bezel 110, having a bezel aperture 112, is secured to the rear housing opening 128.

A method to operate the rear-view assembly for a vehicle as discussed in the examples above comprising at least one camera 106 having the following steps: recording the field of view in the rearward direction, with respect to the vehicle, by the at least one camera 106. Providing at least part of the recorded field of view in the rearwardly facing direction to an electronic control unit (ECU) 130. The ECU 130 provides at least a part of the recorded field of view in the rearwardly facing direction to the driver or user of the vehicle.

The method may further comprise the steps of the first camera 106a recording the field of view in the rearwardly facing direction to the ECU 130, and the second camera 106b recording the field of in the outwardly and/or downwardly facing direction to the ECU 130. The ECU 130 providing at least a part of the recorded field of view in the rearwardly facing directions and the outwardly and/or downwardly facing direction to the driver through a display 132.

The ECU 130 and the display 132 may be located inside of the vehicle. Furthermore, the ECU 130 and the display 132 are communicably coupled to each other so that the ECU 130 may perform suitable adjustment to the images received from the at least one camera 106 (e.g., image cropping, resizing, rotation, etc.) for optimal viewing on the display 132.

In some embodiments, the ECU 130 may be embodied in a number of different ways. For example, the ECU 130 may be embodied as various processing means, such as one or more of a microprocessor or other processing elements, a coprocessor, or various other computing or processing devices, including integrated circuits, such as, for example, an ASIC (application specific integrated circuit), an FPGA (field programmable gate array), or any other suitable device for receiving, processing, storing, and communicating data. In some embodiments, the ECU 130 may be configured to execute instructions stored in a memory provided with the ECU 130 or otherwise accessible to the ECU 130.

As such, whether configured by hardware or by a combination of hardware and software, the ECU 130 may represent an entity (e.g., physically embodied in circuitry—in the form of processing circuitry) capable of performing operations according to some embodiments while configured accordingly. Thus, for example, when the ECU 130 is embodied as an ASIC, FPGA, or the like, the ECU 130 may have specifically configured hardware for conducting the operations described herein. Alternatively, as another example, when the ECU 130 is embodied as an executor of software instructions, the instructions may specifically configure the ECU 130 to perform the operations described herein.

In short, the ECU 130 may include any suitable combination of software, firmware, and hardware. Further, the ECU 130 may include a logic and any appropriate interface for receiving inputs and providing outputs. The logic may include any information, application, rule, and/or instruction stored or executed by the ECU 130. The ECU 130 may additionally include (or be communicatively coupled to) one or more memory modules. The memory modules may be non-transitory and may include any type of volatile or non-volatile memory, including, without limitation, magnetic media, optical media, random access memory (RAM), read-only memory (ROM), removable media, an optical storage device, or any other suitable local or remote memory component. The display 132 is configured to receive signals from the ECU 130 for displaying one or more images or a series of images. In some instances, the display 132 may be configured to receive a video generated by the camera 106. In some examples, the display 132 may be any type of display, including, but not limited to, liquid crystal displays (LCDs), light-emitting diode (LED) displays, organic LED (OLED) displays, digital light processing (DLP) displays, electroluminescent (ELD) displays, plasma display panels (PDPs), and/or the like.

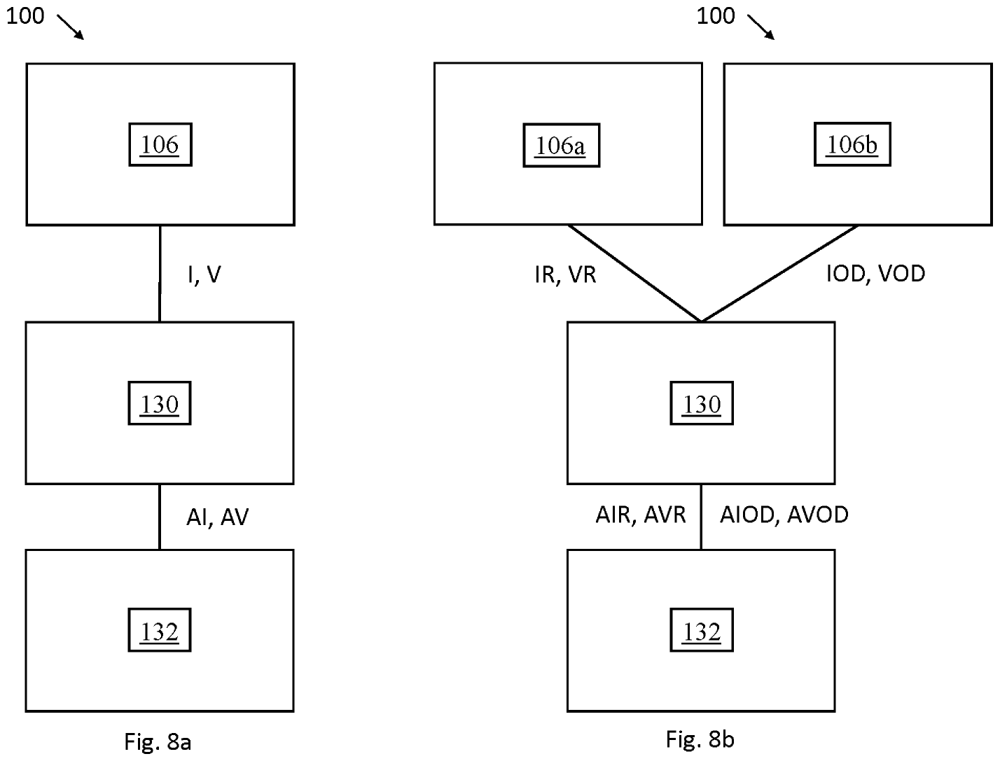

FIG. 8a shows a block diagram of the rear-view assembly 100 with a single camera 160, wherein the camera 106 captures an image I or a video V of the field of view. The image I or video V is then communicated to the ECU 130 where adjustments are made to optimize the image I or video V. The adjusted image AI or adjusted video AV are then shown on the display 132.

FIG. 8b shows a block diagram of the rear-view assembly 100 with two camera, wherein the first camera 106a captures an image IR or a video VR in the rearwardly facing direction, and simultaneously, the second camera 106b captures an image IOD or a video VOD in the outwardly and/or downwardly facing directions. The images IR, IOD or video VR, VOD are then communicated to the ECU 130. The ECU 130 performs adjustments to optimize the image IR, IOD or video VR, VOD. The adjusted image AIR or adjusted video AVR of the rearward direction may be combined with the adjusted image AIOD of video AVOD of the outward and/or downward direction to allow the driver to have an improved field of view on the display 132.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited by the claims and the equivalents thereof.

Furthermore, the features of the disclosure disclosed in this specification, the claims and the drawings may be employed both individually and in any possible combination for practicing the disclosure in its various exemplary embodiments. In particular, all claim feature combinations, irrespective of the claim dependencies, are covered with this application.

### REFERENCE SIGN LIST

100 Rear-view Assembly
102 Housing
104 Frame
106 Camera
106a First Camera
106b Second Camera
108 Lens
108a First Lens
108b Second Lens
110 Bezel
112 Bezel Aperture
114 Cavity
114a First Cavity
114b Second Cavity
116 Cap
116a First Cap—FIG. 3
116b Second Cap—FIG. 3
118 Void
118a first void
118b second void
120 Fastener
122 Actuator
124 Reflective Element
126 Housing Aperture
128 Rear Housing Opening
130 ECU
132 Display
I Image
V Video
AI Adjusted Image
AV Adjusted Video
IR Image Rearward
VR Video Rearward
IOD Image Outward Downward
VOD Video Outward Downward
AVR Adjusted Video Rearward
AIOD Adjusted Image Outward Downward
AVOD Adjusted Video Outward Downward

1-13. (canceled)

14. A rear-view assembly for a vehicle, comprising:
a frame configured to be secured to the vehicle;
a housing secured to the frame;
a first camera secured to the frame, wherein the first camera includes a first lens directed in a rearwardly-facing direction; and
a bezel secured to the frame, wherein the bezel includes a bezel aperture configured for the a first lens to view the rearwardly-facing direction.

15. The rear-view assembly according to claim 14, wherein the frame includes a first cavity to house the first camera.

16. The rear-view assembly according to claim 14, further comprising
a second camera that includes a second lens, wherein the second camera is secured to the frame.

17. The rear-view assembly of claim 16, wherein the frame includes a second cavity that houses the a second camera.

18. The rear-view assembly according to claim 16, wherein the second lens is directed in an outwardly and/or downwardly facing direction.

19. The rear-view assembly according to claim 18, wherein the housing includes a housing aperture configured to allow the second lens of the second camera to view the outwardly and/or downwardly facing direction.

20. The rear-view assembly according to claim 15, wherein the first camera is secured in the first cavity of the frame with a first cap having a first void configured for the first lens to view the rearwardly-facing direction.

21. The rear-view assembly according to claim 15, wherein the first camera is secured in the first cavity of the frame with a first fastener.

22. The rear-view assembly according to claim 21, wherein the first fastener comprises a screw and/or a snap-fit connection.

23. The rear-view assembly according to claim 17, wherein the second camera is secured in the second cavity of the frame with a second fastener.

24. The rear-view assembly of claim 23, wherein the second fastener comprises a screw and/or a snap-fit connection.

25. The rear-view assembly of claim 14, further comprising at least one of a reflective element or an actuator.

26. The rear-view assembly of claim 25, wherein the frame comprises the actuator.

27. The rear-view assembly of claim 14, wherein the reflective element is secured to the actuator.

28. The rear-view assembly of claim 14, wherein the bezel is housed in the housing, and wherein the bezel aperture is configured to allow the first camera to be positioned to view the rearwardly-facing direction.

29. A method of operating a rear-view assembly for a vehicle, comprising:
recording a field of view in a rearwardly-facing direction by a first camera;
providing at least part of the recorded field of view in the rearwardly-facing direction to an electronic control unit (ECU); and
the ECU providing the at least part of the recorded field of view in the rearwardly facing direction to a driver of the vehicle.

30. The method of claim 29, further comprising:
a second camera providing a field of view of an outwardly and/or downwardly facing direction to the ECU; and
the ECU providing at least part of the recorded field of view in the outwardly and/or downwardly facing direction to the driver of the vehicle.

31. A vehicle comprising a rear-view assembly according to claim 14 to provide a field of view to a driver on a display, with at least a part of the field of view in the rearwardly facing and outwardly and/or downwardly facing directions.
